(19) United States
(12) Patent Application Publication
(10) Pub. No.: US 2024/0084165 A1
(43) Pub. Date: Mar. 14, 2024

(54) TWO-PART NON-ISOCYANATE PRIMER COMPOSITIONS

(71) Applicant: AXALTA COATING SYSTEMS IP CO., LLC, Wilmington, DE (US)

(72) Inventors: Delson Trindade, Rochester Hills, MI (US); Shu-jan Liang, Troy, MI (US); Alexander Kauer, Royal Oak, MI (US)

(73) Assignee: AXALTA COATING SYSTEMS IP CO., LLC, Wilmington, DE (US)

(21) Appl. No.: 18/514,426

(22) Filed: Nov. 20, 2023

Related U.S. Application Data
(62) Division of application No. 15/857,442, filed on Dec. 28, 2017, now abandoned.
(60) Provisional application No. 62/440,570, filed on Dec. 30, 2016.

(51) Int. Cl. C09D 167/02; B05D 3/00; C08J 3/24; C09D 5/00; C09D 7/40

(52) U.S. Cl. CPC C09D 167/02; B05D 3/007; C08J 3/24; C09D 5/002; C09D 7/40; B05D 3/0254; C08J 2367/02; C08J 2461/28

(57) ABSTRACT

A method for providing a primer coating on an automotive body component is provided. The method includes mixing a first part comprising polyester and melamine with a second part comprising an unblocked acid catalyst to form a mixed composition; applying the mixed composition to the automotive body component; and curing the mixed composition on the automotive body component at a temperature of less than about 120° C. (250° F.), such as from about 87° C. (190° F.) to about 110° C. (230° F.).

### CROSS-REFERENCE TO RELATED APPLICATIONS

This application is a continuation of U.S. application Ser. No. 15/857,442, filed on Dec. 28, 2017, which claims the benefit of U.S. Provisional Application No. 62/440,570, filed Dec. 30, 2016, the disclosures of which are incorporated herein by reference in their entireties.

### TECHNICAL FIELD

The technical field generally relates to two-part primer compositions for coating substrates that are substantially free of isocyanate and curable at low temperatures.

### BACKGROUND

The use of two-part or two-component (2k) coating compositions based on a polyisocyanate cross-linking agent and a binder component with functional groups containing active hydrogen is widespread in industrial and vehicle coating, due to the very good technological properties of these coating compositions. Such coating compositions are used both in water-based and in solvent-based form. Often, such coating compositions are cured at an elevated temperature during a timed curing operation. Typically, the component on which the coating composition is applied undergoes further processing after the curing operation. Such processing may occur immediately following the curing operation or after a planned or unintentional delay. However, coating compositions that include isocyanate have been found to continue crosslinking after the curing operation ends. Thus, the particular level of crosslinking may differ between components during further processing following the curing operation. For example, the coating on a component that is processed immediately after a curing operation may exhibit less crosslinking than the coating on a component that is processed a day after the curing operation. Differences in the level of crosslinking of coatings may lead to non-uniformity of appearance and behavior.

Further, the ongoing desire for lightweight vehicles has led to both an increase in use of new materials for automotive components, such as high-performance steel, aluminum, plastics and composites, and to an increase in use of thinner and/or lighter automotive components. Often, such components cannot withstand high-bake temperatures typically used when curing conventional coatings on conventional automotive components.

Accordingly, it is desirable to provide a coating composition, such as a primer composition, that exhibits an improved processing window with less time dependence. Also, it is desirable to provide a primer composition that is cured at a reduced temperature as compared to conventional coatings, such as at a temperature of less than about 120° C. Furthermore, other desirable features and characteristics will become apparent from the subsequent detailed description and the appended claims, taken in conjunction with this background.

### BRIEF SUMMARY

In an exemplary embodiment, a two-part (2k) isocyanate-free primer composition is provided. The primer composition includes a first part comprising a polyester and a melamine formaldehyde resin. The primer composition further includes a second part comprising an unblocked acid catalyst. The primer composition is substantially free of isocyanate.

In another embodiment, a two-part (2k) low temperature curable primer composition is provided and includes a first part comprising a first portion of a crosslinkable component and a crosslinking component. The primer composition further includes a second part comprising a second portion of the crosslinkable component and an unblocked acid catalyst. The composition is curable at a temperature of less than about 120° C.

Another embodiment provides a method for providing a primer coating on an automotive body component. The method includes mixing a first part comprising polyester and melamine resin with a second part comprising an unblocked acid catalyst to form a mixed composition. Also, the method includes applying the mixed composition to the automotive body component. Further, the method includes curing the mixed composition on the automotive body component at a temperature of less than about 120° C.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit primer compositions as described herein. Furthermore, there is no intention to be bound by any theory presented in the preceding background or the following detailed description.

A primer composition for coating a substrate is provided herein. The primer composition may be utilized to coat any type of substrate known in the art. In embodiments, the substrate is a vehicle, automobile, or automobile vehicle. “Vehicle” or “automobile” or “automobile vehicle” includes an automobile, such as, car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport.

The exemplary primer composition is isocyanate-free or substantially free of isocyanate. The terminology “substantially free” with regard to the presence of isocyanate in the primer composition means that the primer composition includes less than 0.1 wt. %, alternatively less than 0.05 wt. %, alternatively less than 0.01 wt. %, alternatively less than 0.005 wt. %, or alternatively less than 0.001 wt. %, of isocyanate, based on a total weight of the primer composition.

The exemplary primer composition is a two-part, two-component, or two-pack coating composition. A “two-part”, “two-component” or “two-pack” composition refers to a thermoset coating composition comprising two components that are stored in separate containers, which are typically sealed for increasing the shelf life of the components of the coating composition. The handling of two-component coating compositions generally requires mixing together the reactive components shortly before application to avoid premature reaction of the reactive components. The term “shortly before application” is well-known to a person skilled in the art working with two-component coating compositions. The time period within which the ready-to-use coating composition may be prepared prior to the actual use/application depends on the pot life of the coating composition. The pot life is the time within which, once the mutually reactive components of a coating composition have been mixed, the coating composition may still be properly processed or applied and coatings of unimpaired quality can be achieved. A sufficiently long pot life is desired in order to have a comfortable time window for preparing/mixing and applying the two-component coating compositions. In exemplary embodiments, the primer composition has a pot life of more than about 20 minutes, such as more than about 40 minutes, more than about 60 minutes, more than about 2 hours, more than about 4 hours, for example more than about 8 hours. In an exemplary embodiment, the pot life of the primer composition is up to about 20 hours.

The pot mix is applied as a layer of desired thickness on a substrate surface. After application, the layer dries and cures to form a coating on the substrate surface. A typical two-part coating composition comprises a crosslinkable component and a crosslinking component.

Further, an exemplary primer composition is curable at a reduced temperature as compared to conventional primers, such as at a temperature of less than about 120° C. (250° F.). In an exemplary embodiment, the primer composition is curable at a temperature of less than about 110° C. (230° F.), such as from about 87° C. (190° F.) to about 110° C. (230° F.). For example, the primer composition may be bake cured at a temperature of less than about 120° C., such as from about 87° C. to about 110° C. or from about 100° C. to about 110° C. in an oven during a curing operation for a selected duration. In an exemplary embodiment, the selected duration is about 5 minutes, about 10 minutes, about 15 minutes, about 20 minutes, about 30 minutes, or about 60 minutes.

As used herein, “low VOC coating composition” means a coating composition that includes less than 0.6 kilograms of organic solvent (volatile organic component) per liter (5 pounds per gallon), preferably less than 0.53 kilograms (4.4 pounds per gallon) of the composition. VOC level is determined under the procedure provided in ASTM D3960.

As used herein, “high solids composition” means a coating composition having solid component of above about 40 percent, such as from about 45 to about 85 percent, for example from about 50 to about 65 percent, all in weight percentages based on the total weight of the composition.

As used herein, “GPC weight average molecular weight” means a weight average molecular weight measured by utilizing gel permeation chromatography. A high performance liquid chromatograph (HPLC) supplied by Hewlett-Packard, Palo Alto, Calif. was used. Unless stated otherwise, the liquid phase used was tetrahydrofuran and the standard was polymethyl methacrylate.

As used herein, “Tg” means glass transition temperature. As used herein, “polymer solids” or “binder solids” means a polymer or binder in its dry state.

The exemplary primer composition includes a binder that has a crosslinkable component and a crosslinking component. The “crosslinkable component” includes a compound, oligomer, polymer or copolymer having functional crosslinkable groups positioned in each molecule of the compound, oligomer, the backbone of the polymer, pendant from the backbone of the polymer, terminally positioned on the backbone of the polymer, or a combination thereof. One of ordinary skill in the art would recognize that certain crosslinkable group combinations would be excluded from the crosslinkable component, because, if present, these combinations would crosslink among themselves (self-crosslink), thereby destroying their ability to crosslink with the crosslinking groups in the crosslinking components defined below.

An exemplary crosslinkable component can have on an average 2 to 25, such as 2 to 15, for example 2 to 5, such as 2 to 3, crosslinkable groups selected from hydroxyl, acetoacetoxy, carboxyl, primary amine, secondary amine, epoxy, anhydride, imino, ketimine, aldimine, or a combination thereof. Exemplary functional crosslinkable groups are hydroxyl and imino functional groups. An exemplary crosslinkable component includes a polyester.

Polyesters having hydroxyl crosslinkable functional groups are suitable for the primer composition. An exemplary polyester has a GPC weight average molecular weight exceeding 1500, such as from about 1500 to about 100,000, for example from about 2000 to about 50,000, such as from about 2000 to about 8000, for example from about 2000 to about 5000. The Tg of an exemplary polyester is from about −50° C. to about +100° C., such as from about −20° C. to about +50° C.

An exemplary polyester may be any conventional solvent soluble polyester conventionally polymerized from suitable polyacids, including cycloaliphatic polycarboxylic acids, and suitable polyols, which include polyhydric alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic acid and cyclobutanetetracarboxylic acid. The cycloaliphatic polycarboxylic acids can be used not only in their cis but also in their trans form and as a mixture of both forms. Examples of suitable polycarboxylic acids, which, if desired, can be used together with the cycloaliphatic polycarboxylic acids, are aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid.

Suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, tris(hydroxyethyl), polyethylene glycol and polypropylene glycol. If desired, monohydric alcohols, such as, for example, butanol, octanol, lauryl alcohol, ethoxylated or propoxylated phenols may also be included along with polyhydric alcohols.

In an exemplary embodiment, the primer composition includes more than about 10, such as more than about 15, more than about 20, such as more than about 25, such as more than about 30, for example more than about 33 weight percent crosslinkable component, e.g., polyester, based on the total weight of the primer composition. In an exemplary embodiment, the primer composition includes less than about 60, such as less than about 50, less than about 45, such as less than about 40, such as less than about 35, for example less than about 34 weight percent crosslinkable component, e.g., polyester, based on the total weight of the primer composition.

As used herein the “crosslinking component” is a component that includes a compound, oligomer, polymer or copolymer having crosslinking functional groups positioned in each molecule of the compound, oligomer, the backbone of the polymer, pendant from the backbone of the polymer, terminally positioned on the backbone of the polymer, or a combination thereof, wherein these functional groups are capable of crosslinking with the crosslinkable functional groups on the crosslinkable component (during the curing step) to produce a coating in the form of crosslinked structures. One of ordinary skill in the art would recognize that certain crosslinking group/crosslinkable group combinations would be excluded from embodiments herein, because the crosslinking group/crosslinkable group combinations would fail to crosslink and produce the film forming crosslinked structures.

An exemplary crosslinking component can be selected from a compound, oligomer, polymer or copolymer having crosslinking functional groups selected from the group consisting of melamine, amine, ketimine, epoxy, polyacid, anhydride, and a combination thereof. It would be clear to one of ordinary skill in the art that generally certain crosslinking groups from crosslinking components crosslink with certain crosslinkable groups from the crosslinkable components. Some of those paired combinations include: (1) melamine crosslinking groups generally crosslink with hydroxyl, primary and secondary amine, ketimine, or aldimine crosslinkable groups; (2) ketimine crosslinking groups generally crosslink with acetoacetoxy, epoxy, or anhydride crosslinkable groups; (3) epoxy crosslinking groups generally crosslink with carboxyl, primary and secondary amine, ketimine, or anhydride crosslinkable groups; (4) amine crosslinking groups generally crosslink with acetoacetoxy crosslinkable groups; (5) polyacid crosslinking groups generally crosslink with epoxy crosslinkable groups; and (6) anhydride crosslinking groups generally crosslink with epoxy and ketimine crosslinkable groups. An exemplary crosslinking component is melamine.

Melamine-formaldehyde resins (“melamines”) are well known crosslinking agents for coatings. Melamines can react with hydroxyl functional polymers to form crosslinked coatings. Melamines are commonly used as crosslinking agents in original equipment manufacturing (OEM) coatings for automotive vehicles and light trucks. These OEM coatings are normally baked at high temperatures, such as 130° C. (265° F.) or above. At ambient temperatures, the reaction between hydroxyl groups and melamine functional groups is extremely slow. Some melamines have amino, more properly imino, functional groups. Melamines may be fully formylated, so-called fully alkylated melamines. In addition to being a crosslinking agent, melamine is also known to promote adhesion in adhesives. Due to the requirement for curing at high temperatures, melamine is generally not used in coatings that require curing at lower temperatures.

In an exemplary embodiment, melamines are added to a hydroxyl containing coating composition to provide a resulting coating with improved adhesion and an effective pot life. An exemplary melamine has at least one intact hydrogen in the imino group of the melamine, hereafter referred to as the —NH group, a hydroxyl group, or a combination thereof.

Exemplary melamines having at least one —NH or a hydroxyl group include monomeric melamine, polymeric melamine-formaldehyde resin or a combination thereof. The monomeric melamines include low molecular weight melamines that contain, on an average, three or more methylol groups etherized with a C1 to C5 monohydric alcohol such as methanol, n-butanol, or isobutanol per triazine nucleus. Some such suitable monomeric melamines include alkylated melamines, such as methylated, butylated, isobutylated melamines and mixtures thereof. Many of these suitable monomeric melamines are supplied commercially. For example, Cymel® 303, Cymel® 1168, Cymel® 373, Cymel® 370, Cymel® 380, Cymel® 325, or Cymel® 1158 from Cytec Industries Inc., West Patterson, N.J. may be suitable melamines. Suitable polymeric melamine-formaldehyde resins include high imino (partially formylated, —NH) melamine.

In an exemplary embodiment, the primer composition includes more than about 5, such as more than about 10, such as more than about 15, for example more than about 18 weight percent crosslinking component, e.g., melamine, based on the total weight of the primer composition. In an exemplary embodiment, the primer composition includes less than about 30, such as less than about 25, such as less than about 20, for example less than about 19 weight percent crosslinking component, e.g., melamine, based on the total weight of the primer composition.

In an exemplary embodiment, the primer composition includes melamine formaldehyde resin and butylated melamine formaldehyde resin. In an exemplary embodiment, the primer composition includes more than about 0.5, such as more than about 1, such as more than about 2, for example more than about 3 weight percent melamine formaldehyde resin, based on the total weight of the primer composition. In an exemplary embodiment, the primer composition includes less than about 15, such as less than about 10, such as less than about 5, for example less than about 4 weight percent melamine formaldehyde resin, based on the total weight of the primer composition. In an exemplary embodiment, the primer composition includes more than about 2, such as more than about 5, such as more than about 10, for example more than about 14 weight percent butylated melamine formaldehyde resin, based on the total weight of the primer composition. In an exemplary embodiment, the primer composition includes less than about 25, such as less than about 20, such as less than about 18, for example less than about 15 weight percent butylated melamine formaldehyde resin, based on the total weight of the primer composition.

An exemplary crosslinkable component may have from about 1 to about 99, from about 10 to about 50, from about 20 to about 40, or from about 30 to about 35 weight percent of total solid weight of the primer composition a polyester having hydroxyl crosslinkable groups, and from about 1 to about 35, from about 5 to about 30, from about 10 to about 25, from about 15 to about 20, or from about 18 to about 19, weight percent of total solid weight of the primer composition a melamine having crosslinkable groups selected from an —NH group, a hydroxyl group, or a combination thereof.

In an exemplary embodiment, the polyester and melamine are provided in the primer composition in a polyester:melamine weight ratio of from about 0.5:1 to about 5:1, such as from about 1:1 to about 3:1, for example from about 1.5:1 to about 2:1.

In an embodiment, the two-part primer composition includes a first part or component and a second part or component. In an exemplary embodiment, the crosslinking component is contained within the first part of the two-part primer composition. Further, a first portion of the crosslinkable component is contained within the first part of the two-part primer composition. A second portion of the crosslinkable component may be contained within the second part of the two-part primer composition.

In an exemplary embodiment, about 1, about 2, about 5, about 10, about 15, about 20, about 25, about 30, about 35, about 40, about 45, about 50, about 55, about 60, about 65, about 70, about 75, about 80, about 85, about 90, about 95, about 98, or about 99 weight percent of the crosslinkable component, based on the total weight of the crosslinkable component, is contained in the first part of the primer composition while the remainder of the crosslinkable component is contained in the second part of the primer composition.

The second part of the primer composition further includes a crosslinking catalyst. An exemplary crosslinking catalyst is unblocked. For example, the crosslinking catalyst may be an unblocked acid catalyst. An exemplary unblocked acid catalyst is aromatic sulfonic acid. For example, the unblocked acid catalyst may be dodecylbenzenesulfonic acid (DDBSA). Other suitable unblocked catalysts, such as unblocked acid catalysts may be utilized. In an exemplary embodiment, the second part of the primer composition consists essentially of the unblocked acid catalyst or of the unblocked acid catalyst and the second portion of the crosslinkable component. Further, in an exemplary embodiment, the first part of the primer composition is substantially free of crosslinking catalyst. The terminology “substantially free” with regard to the presence of crosslinking catalyst in the first part of the primer composition means that the first part of the primer composition includes less than 0.1 wt. %, alternatively less than 0.05 wt. %, alternatively less than 0.01 wt. %, alternatively less than 0.005 wt. %, or alternatively less than 0.001 wt. %, of the crosslinking catalyst, based on a total weight of the primer composition.

In an exemplary embodiment, the second part of the primer composition includes a catalytic amount of the catalyst for accelerating the curing process. The catalytic amount may depend upon the reactivity of the primary hydroxyl group of the reactive oligomer present in the hydroxyl component of the binder. In an exemplary embodiment, the primer composition includes about 0.001 percent to about 5 percent, such as from about 0.01 percent to 2 percent, for example from about 0.02 percent to 1 percent, such as about 0.6 percent, all in weight percent based on the total weight of the primer composition, of the catalyst.

In an exemplary embodiment, the first part of the primer composition, which may be formulated into high solids coating systems further contains at least one organic solvent. An exemplary organic solvent may be selected from the group consisting of aromatic hydrocarbons, such as, petroleum naphtha or xylenes; ketones, such as, methyl amyl ketone, methyl isobutyl ketone, methyl ethyl ketone or acetone; esters, such as, butyl acetate or hexyl acetate; and glycol ether esters, such as propylene glycol monomethyl ether acetate. The amount of organic solvent added depends upon the desired solids level as well as the desired amount of VOC of the composition.

In an exemplary embodiment, the first part of the primer composition may further include at least one alcohol solvent. An exemplary alcohol solvent is n-butyl alcohol and/or isobutyl alcohol, though other suitable alcohol solvents may be used.

The first part of the primer composition may also contain conventional, well known in the art, additives, such as pigments, stabilizers, rheology control agents, flow agents, toughening agents, UV protection agents, moisture scavenger and fillers. Such additional additives will, of course, depend on the intended use of the coating composition. Conductive pigments, such as carbon black pigments, conductive graphite, metal particles, or conductive polymers, may be added to the coating composition. An exemplary first part may include a flow additive, such as an acrylic copolymer flow additive, or other acrylic polymers, reactive oligomers, or combinations thereof, as is well known in the coating industry. Also, the first part may include various pigments, such as in the form of pigment dispersions.

The first part and second part may be mixed just prior to use or about 5 to 30 minutes before use to form a pot mix, which has limited pot life. A layer of the pot mix is typically applied to a substrate by conventional techniques, such as, spraying, electrostatic spraying, roller coating, dipping or brushing. The layer of the coating composition then cures at a temperature of less than about 120° C., such as from about 88 to about 110° C. or from about 100 to about 110° C. for a selected duration of in the range of 30 minutes to 24 hours to form a coating on the substrate having desired coating properties. It is understood that the actual curing time depends upon the thickness of the applied layer and on any additional mechanical aids, such as, fans that assist in continuously flowing air over the coated substrate to accelerate the cure rate.

The exemplary primer composition can be applied to metal or non-metallic substrates. One example of non-metal substrate include plastics or composite plastics including SMC, GTX, nylon, melamine and/or acrylic composites, TPO, TPV, polypropylene, PVC, Styrofoam, polycyclopentadiene and the like. By “plastic” is meant any of the common thermoplastic or thermosetting synthetic nonconductive materials, including thermoplastic olefins such as polyethylene and polypropylene, thermoplastic urethane, polycarbonate, thermosetting sheet molding compound, reaction-injection molding compound, acrylonitrile-based materials, nylon, and the like.

Exemplary primer compositions are particularly useful for forming a primer layer that is to be coated with one or more other coating layers such as a basecoat layer and a subsequent topcoat layer. The exemplary primer composition can be used as a primer for OEM automotive vehicle coatings or refinish vehicle coatings. The exemplary primer composition can also be used to coat devices or appliances having plastic or non-plastic parts thereof, such as, but not limited to, digital devices, such as cell phones, handheld calculators, personal digital assistants (PDAs), desktop computers, laptop computers, or tablet computers; household appliances, such as microwaves, refrigerators, washer and dryers, televisions, or telephone; sports equipment; or tools and protection equipment.

In certain embodiment, the primer composition may be characterized as including a first polymer, a second polymer, and a solvent. In embodiments, the first polymer and the second polymer are identified as being part of a binder polymer component. The term “binder polymer component” refers to film forming constituents of a coating composition. Typically, a binder polymer component can comprise polymers, oligomers, and a combination thereof that are essential for forming a coating having desired properties, such as hardness, protection, adhesion, and others. Additional components, such as solvents, pigments, catalysts, rheology modifiers, antioxidants, UV stabilizers and absorbers, leveling agents, antifoaming agents, anti-cratering agents, or other conventional additives are not included in the term. One or more of those additional components can be included in the coating composition. In embodiments, and as described in greater detail below, the coating composition further includes other components, such as non-functional polymers, crosslinking agents, pigments, and additives.

The first polymer includes a first polymer-bound moiety having an acid-functional group, or a derivative thereof. The second polymer includes a second polymer-bound moiety having an amine-functional group. The acid-functional group and the amine-functional group are substantially reactive to each other at least after application of the coating composition to the substrate. The terminology “substantially” with regard to the reactivity of the acid-functional group and the amine-functional group to each other means that at least 60, alternatively at least 75, alternatively at least 85, alternatively at least 90, alternatively at least 95, or alternatively at least 99% of the acid-functional groups and the amine-functional groups are reactive to each other. In embodiments, when the first and second polymers are dissolved in solvent, such as a polar solvent, ionic interactions between the acid-functional groups and the amine-functional groups are minimized thereby resulting in a coating composition that exhibits minimal gelling. Also in embodiments, after evaporation of the solvent, such as after application of the coating composition to the substrate, the first and second polymers are reactive to each other through ionic interactions between the acid-functional groups and the amine-functional groups thereby forming a coating layer, after curing, having improved coating performance, such as adhesion.

The first polymer is substantially free of amine-functional groups and the second polymer is substantially free of acid-functional groups. The terminology “substantially free” with regard to the presence of amine-functional groups in the first polymer means that the mixture utilized to form the first polymer includes less than 0.1 wt. %, alternatively less than 0.05 wt. %, alternatively less than 0.01 wt. %, alternatively less than 0.005 wt. %, or alternatively less than 0.001 wt. %, of amine-functional groups, based on a total weight of the mixture. The terminology “substantially free” with regard to the presence of acid-functional groups in the second polymer means that the mixture utilized to form the second polymer includes less than 0.1 wt. %, alternatively less than 0.05 wt. %, alternatively less than 0.01 wt. %, alternatively less than 0.005 wt. %, or alternatively less than 0.001 wt. %, of acid-functional groups, based on a total weight of the mixture.

The first polymer may be utilized in the coating composition in an amount of from 10 to 90 wt. %, alternatively from 10 to 80 wt. %, or alternatively from 10 to 60 wt. %, based on a total weight of the binder polymer component of the coating composition. The second polymer may be utilized in the coating composition in an amount of from 10 to 90 wt. %, alternatively from 10 to 80 wt. %, or alternatively from 10 to 60 wt. %, based on a total weight of the binder polymer component of the coating composition. In embodiments, the acid-functional groups of the first polymer and the amine-functional groups of the second polymer are utilized in the coating composition at a molar ratio of acid-functional groups to amine-functional groups from 10:1 to 1:10, alternatively from 5:1 to 1:5, or alternatively from 4:1 to 1:4.

The first polymer includes a first polymer-bound moiety having an acid-functional group, or a derivative thereof. The first polymer-bound moiety may be at least a portion of the backbone of the first polymer, may be a side-chain of the first polymer, may be grafted to the first polymer, or combinations thereof. The first polymer may include more than one first polymer-bound moiety with the polymer-bound moieties in any position of the first polymer. In certain embodiments, the first polymer-bound moiety is the first polymer. The first polymer-bound moiety may be formed from an acid-functional monomer, an acid-functional oligomer, or an acid-functional macromonomer. In embodiments, the monomer, the oligomer, or the macromonomer includes a polymerizable double bond, such as an ethylenically unsaturated double bond. In embodiments, the first polymer is a copolymer. The copolymer may be a random copolymer, an alternating copolymer, a periodic copolymer, a statistical copolymer, a block copolymer, or a graft copolymer. The copolymer may be linear or branched.

The acid-functional group, or a derivative thereof, may be a carboxylic acid group, sulfonic acid group, phosphoric acid group, or an acid anhydride group. The first polymer-bound moiety may have more than one type of acid-functional group, or a derivative thereof. In certain embodiments, the acid-functional group, or a derivative thereof, is a carboxylic acid group.

In embodiments, the first polymer-bound moiety is polymerized from a first polymer monomer mixture including acid-functional monomers. In certain embodiments, the acid-functional monomers are selected from the group of (meth)acrylic acid, crotonic acid, oleic acid, cinnamic acid, glutaconic acid, muconic acid, undecylenic acid, itaconic acid, crotonic acid, fumaric acid, maleic acid, and combinations thereof. In embodiments, the first polymer monomer mixture may include acid anhydrides of any of the acid-functional monomers. Suitable acid anhydrides include maleic anhydride and itaconic anhydride. In these embodiments, the acid anhydride monomers may be hydrolyzed to form the corresponding carboxyl groups. It is to be appreciated that the first polymer monomer mixture may include acid-functional monomers and acid anhydrides monomers.

In embodiments, the first polymer monomer mixture includes the acid-functional monomers, or derivatives thereof, in an amount of from about 0.1 to about 12 wt. %, alternatively from about 0.5 to 10 wt. %, alternatively from about 0.5 to 8 wt. %, or alternatively from about 1 to about 5 wt. %, based on a total weight of the first polymer monomer mixture. Without being bound by theory, it is believed that a polymer polymerized from a polymer monomer mixture including acid-functional monomers in an amount of greater than 12 wt. % will result in a coating composition having moisture sensitivity and result in gelling of the coating composition due to reactivity with the second polymer. Without being bound by theory, it is also believed that a polymer polymerized from a polymer monomer mixture including acid-functional monomers in an amount of less than 0.1 wt. % will result in a polymer that insufficiently reacts with the second polymer.

The first polymer may have a weight average molecular weight in an amount of from about 5,000 to about 200,000, alternatively from about 8,000 to about 200,000, or alternatively from about 10,000 to about 200,000. “Molecular weights” disclosed herein can be determined by gel permeation chromatography (GPC) using polystyrene as the standard unless specified otherwise. The first polymer may have a polydispersity in an amount of from about 1.05 to about 10.0, alternatively from about 1.2 to about 8, or alternatively from about 1.5 to about 5. The first polymer may have a Tg of in an amount of from about −5° C. to about 100° C., alternatively from about 0° C. to 80° C., or alternatively from about 10° C. to about 60° C. “Tg” means glass transition temperature of the polymer and can be measured by differential scanning calorimetry (DSC) or can be calculated as described by Fox in Bull. Amer. Physics Soc., 1, 3, page 123 (1956). Without being bound by theory, it is believed that the first polymer having the weight average molecular weight described above provides a coating composition exhibiting minimal gelling and improved coating performance, such as improved adhesion. In particular, polymers having a weight average molecular weight of less than 5,000 may evaporate out of the coating composition prior to reacting with the second polymer and curing. Further, polymers having a weight average molecular weight of greater than 200,000 may result in a coating composition having a viscosity not suitable for spray applications of the coating composition. The first polymer can include one or more polymers each having at least an acid-functional group, or a derivative thereof. Each of the polymers can have more than one type of acid-functional group, or a derivative thereof.

The second polymer includes a second polymer-bound moiety having an amine-functional group. The amine-functional group may be a primary amine, a secondary amine, or a tertiary amine. The second polymer-bound moiety may be at least a portion of the backbone of the second polymer, may be a side-chain of the second polymer, may be grafted to the second polymer, or combinations thereof. The second polymer may include more than one second polymer-bound moiety with the polymer-bound moieties in any position of the second polymer. In certain embodiments, the second polymer-bound moiety is the second polymer. The second polymer-bound moiety may be formed from an amine-functional monomer, an amine-functional oligomer, or an amine-functional macromonomer. In embodiments, the monomer, the oligomer, or the macromonomer includes a polymerizable double bond, such as an ethylenically unsaturated double bond. In embodiments, the second polymer is a copolymer. The copolymer may be a random copolymer, an alternating copolymer, a periodic copolymer, a statistical copolymer, a block copolymer, or a graft copolymer. The copolymer may be linear or branched.

In embodiments, the second polymer-bound moiety may be polymerized from a second polymer monomer mixture including amine-functional monomers, carboxyl-functional monomers, or a combination thereof. In one embodiment, the second polymer-bound moiety may be polymerized from a second polymer monomer mixture including amine-functional monomers. The amine-functional monomers may be selected from the group of t-butylaminoethyl methacrylate (t-BAEMA), N,N-dimethylaminoethyl acrylate (DMAEA), and combinations thereof. In another embodiment, the second polymer-bound moiety is polymerized from a second polymer monomer mixture including carboxyl-functional monomers. The carboxyl-functional monomers may be methacrylic acid. In embodiments when the second polymer is polymerized from carboxyl-functional monomers, such as methacrylic acid, the second polymer is reacted with an imine compound, such as propylene imine, to form primary amine-functional groups. Secondary amine-functional groups may be polymerized from t-BAEMA. Alternatively, secondary amine-functional groups may polymerized from a polymer including epoxy-functional groups and an amine compound, such as a primary amine and an alkanol amine. Tertiary amine-functional groups may be polymerized from N,N-dialkylaminoalkyl acrylates, such as N,N-dimethylaminoethyl acrylate and N,N-diethylaminoethyl acrylate, and N,N-dialkylaminoalkyl methacrylate, such as N,N-dimethylaminoethyl methacrylate and N,N-diethylaminoethyl methacrylate.

In embodiments, the second polymer monomer mixture includes the amine-functional monomers, in an amount of from about 0.1 to about 15 wt. %, alternatively from about 0.5 to 12 wt. %, alternatively from about 0.5 to 10 wt. %, or alternatively from about 1 to about 7 wt. %, based on a total weight of the second polymer monomer mixture. Without being bound by theory, it is believed that a polymer polymerized from a polymer monomer mixture including amine-functional monomers in an amount of greater than 15 wt. % will result in a coating composition in gelling of the coating composition due to reactivity with the first polymer. Without being bound by theory, it is also believed that a polymer polymerized from a polymer monomer mixture including amine-functional monomers in an amount of less than 0.1 wt. % will result in a polymer that insufficiently reacts with the first polymer.

The second polymer may have a weight average molecular weight in an amount of from about 5,000 to about 200,000, alternatively from about 8,000 to about 200,000, or alternatively from about 10,000 to about 200,000. The second polymer may have a polydispersity in an amount of from about 1.05 to about 10.0, alternatively from about 1.2 to about 8, or alternatively from about 1.5 to about 5. The second polymer may have a Tg of in an amount of from about −5° C. to about 100° C., alternatively from about 0° C. to 80° C., or alternatively from about 10° C. to about 60° C. Without being bound by theory, it is believed that the second polymer having the weight average molecular weight described above provides a coating composition exhibiting minimal gelling and improved coating performance, such as improved adhesion. In particular, polymers having a weight average molecular weight of less than 5,000 may evaporate out of the coating composition prior to reacting with the first polymer and curing. Further, polymers having a weight average molecular weight of greater than 200,000 may result in a coating composition having a viscosity not suitable for spray applications of the coating composition. The second polymer can include one or more polymers each having at least an amine-functional group, or a derivative thereof. Each of the polymers can have more than one type of amine-functional group, or a derivative thereof.

In embodiments, the first polymer, the second polymer, or both the first polymer and the second polymer, have a crosslinkable-functional group. The term “crosslinkable-functional group” refers to functional groups that are positioned in each molecule of the compounds, oligomer, polymer, the backbone of the polymer, pendant from the backbone of the polymer, terminally positioned on the backbone of the polymer, or combinations thereof, wherein these functional groups are capable of crosslinking with crosslinking-functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking-functional groups. A workable combination of crosslinkable-functional groups refers to the combinations of crosslinkable-functional groups that can be used in coating applications excluding those combinations that would self-crosslink.

Typical crosslinkable-functional groups can include hydroxyl, thiol, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

In certain embodiments, the crosslinkable-functional group is a hydroxyl-functional group. The hydroxyl-functional group may be a primary hydroxyl groups, a secondary hydroxyl groups, or a combination thereof. The first polymer having the hydroxyl-functional group may be polymerized from the first polymer monomer mixture further including hydroxyl-functional monomers. The second polymer having the hydroxyl-functional group may be polymerized from the second polymer monomer mixture further including hydroxyl-functional monomers. Non-limiting examples of hydroxyl-functional monomers utilized to form primary hydroxyl groups includes 2-hydroxyethyl methacrylate (HEMA), and 2-hydroxyethyl acrylate (HEA). Non-limiting examples of hydroxyl-functional monomers utilized to form secondary hydroxyl groups includes hydroxypropyl methacrylate (HPMA) and hydroxypropyl acrylate (HPA). In certain embodiments, the hydroxyl-functional monomers are selected from the group of 2-hydroxyethyl (meth)acrylate, hydroxypropyl (meth)acrylate, and combinations thereof. It is to be appreciated that the selection of hydroxyl-functional groups for the first polymer are independent of the selection of hydroxyl-functional groups for the second polymer, and vice-versa. In other embodiments, the crosslinkable-functional group is a thiol-functional group. In various embodiments, the crosslinkable-functional group of only the second polymer is the amine-functional group.

In embodiments, the first polymer, the second polymer, or both the first polymer and the second polymer are polymerized from additional monomers, such as any acrylic monomer known in the art and any ethylenically unsaturated monomer known in the art. Non-limiting examples of these additional monomers includes unsubstituted or substituted alkyl acrylates, such as those having 1-20 carbon atoms in the alkyl group; alkyl methacrylate such as those having 1-20 carbon atoms in the alkyl group; cycloaliphatic acrylates; cycloaliphatic methacrylates; aryl acrylates; aryl methacrylates; other ethylenically unsaturated monomers such as acrylonitriles, methacrylonitriles, acrylamides, methacrylamides, N-alkylacrylamides, N-alkylmethacrylamides, N,N-dialkylacrylamides, N,N-dialkylmethacrylamides; vinyl aromatics such as styrene, and combinations thereof. Other non-limiting examples include non-functional acrylic monomers, such as methyl methacrylate, ethyl methacrylate, propyl methacrylate (all isomers), butyl methacrylate (all isomers), 2-ethylhexyl methacrylate, isobornyl methacrylate, methacrylonitrile, methyl acrylate, ethyl acrylate, propyl acrylate (all isomers), butyl acrylate (all isomers), 2-ethylhexyl acrylate, isobornyl acrylate, acrylonitrile and the like. Further non-limiting examples includes other ethylenically unsaturated monomers, such as, vinyl aromatics. Non-limiting examples of vinyl aromatics includes styrene, alpha-methyl styrene, t-butyl styrene, and vinyl toluene. In certain embodiments, the first polymer, the second polymer, or both the first polymer and the second polymer are polymerized from additional monomers selected from the group of styrene, methyl (meth)acrylate, butyl (meth)acrylate, ethylhexyl (meth)acrylate, isobornyl (meth)acrylate, and combinations thereof. It is to be appreciated that the selection of additional monomers for the first polymer are independent of the selection of additional monomers for the second polymer, and vice-versa.

In an exemplary embodiment, the first polymer includes the reaction product of styrene, butyl acrylate, isobornyl acrylate, 2-hydroxyethyl methacrylate, hydroxypropyl methacrylate, and methacrylic acid. The styrene may be utilized in an amount of from about 10 to about 50 wt. %, alternatively from about 20 to about 40 wt. %, or alternatively from about 25 to about 35 wt. %, each based on a total weight of the first polymer. The butyl acrylate may be utilized in an amount of from about 10 to about 50 wt. %, alternatively from about 20 to about 40 wt. %, or alternatively from about 25 to about 35 wt. %, each based on a total weight of the first polymer. The isobornyl acrylate may be utilized in an amount of from 1 to 40 wt. %, alternatively from about 10 to about 30 wt. %, or alternatively from about 15 to about 25 wt. %, each based on a total weight of the first polymer. The 2-hydroxyethyl methacrylate may be utilized in an amount of from 0.1 to 30 wt. %, alternatively from about 1 to about 20 wt. %, or alternatively from about 3 to about 12 wt. %, each based on a total weight of the first polymer. The hydroxypropyl methacrylate may be utilized in an amount of from 0.1 to 30 wt. %, alternatively from about 1 to about 20 wt. %, or alternatively from about 3 to about 12 wt. %, each based on a total weight of the first polymer. The methacrylic acid may be utilized in an amount of from 0.1 to 12 wt. %, alternatively from about 1 to about 9 wt. %, or alternatively from about 3 to about 7 wt. %, each based on a total weight of the first polymer.

In another exemplary embodiment, the first polymer includes the reaction product of methyl methacrylate, butyl methacrylate, ethylhexyl acrylate, 2-hydroxyethyl methacrylate, and methacrylic acid. The methyl methacrylate may be utilized in an amount of from about 10 to about 50 wt. %, alternatively from about 20 to about 40 wt. %, or alternatively from about 25 to about 35 wt. %, each based on a total weight of the first polymer. The butyl methacrylate may be utilized in an amount of from about 5 to about 45 wt. %, alternatively from about 15 to about 35 wt. %, or alternatively from about 20 to about 30 wt. %, each based on a total weight of the first polymer. The ethylhexyl acrylate may be utilized in an amount of from about 5 to about 45 wt. %, alternatively from about 15 to about 35 wt. %, or alternatively from about 20 to about 30 wt. %, each based on a total weight of the first polymer. The 2-hydroxyethyl methacrylate may be utilized in an amount of from 0.1 to 40 wt. %, alternatively from about 10 to about 30 wt. %, or alternatively from about 15 to about 25 wt. %, each based on a total weight of the first polymer. The methacrylic acid may be utilized in an amount of from 0.1 to 12 wt. %, alternatively from about 0.1 to about 8 wt. %, or alternatively from about 0.1 to about 4 wt. %, each based on a total weight of the first polymer.

In an exemplary embodiment, the second polymer includes the reaction product of methyl methacrylate, butyl acrylate, and t-butylaminoethyl methacrylate. The methyl methacrylate may be utilized in an amount of from about 60 to about 90 wt. %, alternatively from about 70 to about 85 wt. %, or alternatively from about 75 to about 81 wt. %, each based on a total weight of the second polymer. The butyl acrylate may be utilized in an amount of from about 5 to about 25 wt. %, alternatively from about 10 to about 20 wt. %, or alternatively from about 12 to about 18 wt. %, each based on a total weight of the second polymer. The t-butylaminoethyl methacrylate may be utilized in an amount of from 0.1 to 12 wt. %, alternatively from about 3 to about 10 wt. %, or alternatively from about 5 to about 9 wt. %, each based on a total weight of the second polymer.

In another exemplary embodiment, the second polymer includes the reaction product of methyl methacrylate, ethyl acrylate, and t-butylaminoethyl methacrylate. The methyl methacrylate may be utilized in an amount of from about 60 to about 90 wt. %, alternatively from about 70 to about 85 wt. %, or alternatively from about 75 to about 81 wt. %, each based on a total weight of the second polymer. The ethyl acrylate may be utilized in an amount of from about 5 to about 25 wt. %, alternatively from about 10 to about 20 wt. %, or alternatively from about 12 to about 18 wt. %, each based on a total weight of the second polymer. The t-butylaminoethyl methacrylate may be utilized in an amount of from 0.1 to 12 wt. %, alternatively from about 3 to about 10 wt. %, or alternatively from about 5 to about 9 wt. %, each based on a total weight of the second polymer.

In another exemplary embodiment, the second polymer includes the reaction product of methyl methacrylate, butyl acrylate, and N,N-dimethylaminoethyl acrylate. The methyl methacrylate may be utilized in an amount of from about 60 to about 90 wt. %, alternatively from about 70 to about 85 wt. %, or alternatively from about 75 to about 81 wt. %, each based on a total weight of the second polymer. The butyl acrylate may be utilized in an amount of from about 5 to about 25 wt. %, alternatively from about 10 to about 20 wt. %, or alternatively from about 12 to about 18 wt. %, each based on a total weight of the second polymer. The N,N-dimethylaminoethyl acrylate may be utilized in an amount of from 0.1 to 12 wt. %, alternatively from about 3 to about 10 wt. %, or alternatively from about 5 to about 9 wt. %, each based on a total weight of the second polymer.

In another exemplary embodiment, the second polymer includes the reaction product of methyl methacrylate, ethyl acrylate, and the reaction product of methacrylic acid and propylene imine. The methyl methacrylate may be utilized in an amount of from about 65 to about 95 wt. %, alternatively from about 73 to about 87 wt. %, or alternatively from about 77 to about 83 wt. %, each based on a total weight of the second polymer. The ethyl acrylate may be utilized in an amount of from about 5 to about 25 wt. %, alternatively from about 10 to about 20 wt. %, or alternatively from about 12 to about 18 wt. %, each based on a total weight of the second polymer. The methacrylic acid may be utilized in an amount of from 0.1 to 12 wt. %, alternatively from about 1 to about 7 wt. %, or alternatively from about 2 to about 6 wt. %, each based on a total weight of the second polymer. The propylene imine may be utilized in an amount of from 0.1 to 12 wt. %, alternatively from about 1 to about 7 wt. %, or alternatively from about 1 to about 5 wt. %, each based on a total weight of the second polymer.

In another exemplary embodiment, the second polymer includes the reaction product of methyl methacrylate, butyl acrylate, 2-hydroxyethyl acrylate, and N,N-dimethylaminoethyl acrylate. The methyl methacrylate may be utilized in an amount of from about 60 to about 90 wt. %, alternatively from about 70 to about 85 wt. %, or alternatively from about 75 to about 81 wt. %, each based on a total weight of the second polymer. The butyl acrylate may be utilized in an amount of from about 0.1 to about 15 wt. %, alternatively from about 1 to about 15 wt. %, or alternatively from about 3 to about 8 wt. %, each based on a total weight of the second polymer. The 2-hydroxyethyl acrylate may be utilized in an amount of from about 0.1 to about 25 wt. %, alternatively from about 1 to about 17 wt. %, or alternatively from about 7 to about 13 wt. %, each based on a total weight of the second polymer. The N,N-dimethylaminoethyl acrylate may be utilized in an amount of from 0.1 to 12 wt. %, alternatively from about 1 to about 10 wt. %, or alternatively from about 4 to about 10 wt. %, each based on a total weight of the second polymer.

The first polymer, the second polymer, or both the first polymer and the second polymer are independently selected from a linear or branched acrylic polymer, a linear or branched polyester polymer, a polyurethane polymer, or combinations thereof. “Acrylic polymer” means a polymer comprises polymerized “(meth)acrylate(s)” which mean acrylates and/or methacrylates, optionally copolymerized with other ethylenically unsaturated monomers, such as acrylamides, methacrylamides, acrylonitriles, methacrylonitriles, and vinyl aromatics, such as styrene.

In embodiments, the first polymer, the second polymer, or both the first polymer and the second polymer are polyester polymers. The polyester polymer may be linear or branched. Useful polyesters can include esterification products of aliphatic or aromatic dicarboxylic acids, polyols, diols, aromatic or aliphatic cyclic anhydrides and cyclic alcohols. It is to be appreciated that the selection of the polyester for the first polymer is independent of the selection of the polyester for the second polymer, and vice-versa.

Non-limiting examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further non-limiting examples of suitable polycarboxylic acids can include aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols can also be suitable.

Non-limiting suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. If desired, monohydric alcohols, such as, for example, butanol, octanol, lauryl alcohol, ethoxylated or propoxylated phenols may also be included along with polyhydric alcohols.

Non-limiting examples of suitable polyesters include a branched copolyester polymer. The branched copolyester polymer and process for production described in U.S. Pat. No. 6,861,495, which is hereby incorporated by reference, can be suitable. Monomers with multifunctional groups such as ABx (x=1-3) types including those having one carboxyl group and two hydroxyl groups, two carboxyl groups and one hydroxyl group, one carboxyl group and three hydroxyl groups, or three carboxyl groups and one hydroxyl group can be used to create branched structures. Non-limiting examples of such monomers include 2,3 dihydroxy propionic acid, 2,3 dihydroxy 2-methyl propionic acid, 2,2 dihydroxy propionic acid, 2,2-bis(hydroxymethyl) propionic acid, and the like.

The branched copolyester polymer can be conventionally polymerized from a monomer mixture containing a chain extender selected from the group of a hydroxy carboxylic acid, a lactone of a hydroxy carboxylic acid, and a combination thereof; and one or more branching monomers. Some of the suitable hydroxy carboxylic acids include glycolic acid; lactic acid; 3-hydroxycarboxylic acids, such as 3-hydroxypropionic acid, 3-hydroxybutyric acid, 3-hydroxyvaleric acid, and hydroxypyvalic acid. Some of the suitable lactones include caprolactone, valerolactone; and lactones of the corresponding hydroxy carboxylic acids, such as, glycolic acid; lactic acid; 3-hydroxycarboxylic acids, e.g., 3-hydroxypropionic acid, 3-hydroxybutyric acid, 3-hydroxyvaleric acid, and hydroxypyvalic acid. In certain embodiments, caprolactone can is utilized. In embodiments, the branched copolyester polymer can be produced by polymerizing, in one step, the monomer mixture that includes the chain extender and hyper branching monomers, or by first polymerizing the hyper branching monomers followed by polymerizing the chain extenders.

In embodiments when the first polymer is a polyester polymer (also referred to herein as “acid-functional polyester”), the first polymer may be produced by using excess amounts of diacids or anhydrides with polyols or other methods known to those skilled in the art in the synthesis to ensure that the polymer chains are terminated with acid-functional groups in a linear or branched structure. Alternatively, the polyesters with hydroxy groups at the terminal positions of the polymer chain can be post-reacted with a diacid or an anhydride to form acid-functional groups.

In embodiments when the second polymer is a polyester polymer (also referred to herein as “amine-functional polyester”), the second polymer can be produced by including an amine-functional polyol such as a tertiary amine-functional polyol with polyacids and polyols in the synthesis or other methods known to those killed in the art. Non-limiting examples of monomers having only one reactive group that is capable of condensing with acids or anhydrides and place the tertiary amine functional group at the terminal position of a polymer chain include, N, N-dimethyl ethanol amine, N, N-diethyl ethanol amine, 1-dimethyl amino-2-propanol, 3-dimethyl amino-1-propanol, 2-dimethyl amino-2-methyl-1-propanol, and the likes. Non-limiting examples of polyhydroxyl with tertiary amine groups that can place the amine functional groups along the polymer chains include simple compounds, such as N-methyl diethanol amine, N-ethyl diethanol amine, N-butyl diethanol amine, N,N-dibutyl ethanol amine, triethanol amine, triisopropanol amine, and compounds commercially available from Akzo Nobel N.V. of Amsterdam, Netherlands under the trade names Ethomeen® (one tertiary amine nitrogen atom) and Ethoduomeen® (two tertiary amine nitrogen atoms). The second polymer can also undergo post polymerization, such as by reacting carboxylic acid containing polyester polymers described above with appropriate amine compounds, such as propylene imine.

As introduced above, the coating composition further includes a solvent. In embodiments, the solvent is an organic solvent. The organic solvent may be the liquid carrier to disperse and/or dilute the above ingredients and form a coating composition having the desired properties. The solvent or solvent blends are typically selected from the group of aromatic hydrocarbons, such as, petroleum naphtha or xylenes; ketones, such as, methyl amyl ketone, methyl isobutyl ketone, methyl ethyl ketone or acetone; esters, such as butyl acetate or hexyl acetate; glycol ether esters, such as, propylene glycol monomethyl ether acetate; and alcohols, such as isopropanol and butanol, and combinations thereof. The amount of organic solvent added depends upon the desired solids level, desired rheological (e.g., spray) properties, as well as the desired amount of VOC of the primer composition. The organic solvent may be present in an amount of from 10 to 95 wt. %, alternatively from 10 to 50 wt. %, or alternatively from 20 to 30 wt. %, based on a total weight of the primer composition.

The total solids level of the primer composition may be in an amount of from about 5 to about 90 wt. %, alternatively in an amount of from about 5 to about 80 wt. % or alternatively in an amount of from about 5 to about 60 wt. %, based on a total weight of the primer composition.

In embodiments, the coating composition is a waterborne primer composition. In other embodiments, the primer composition is a solventborne coating composition. In certain embodiments, the primer composition is substantially free of water. The terminology “substantially free” with regard to the amount of water in the primer composition means that the primer composition includes less than 5 wt. %, alternatively less than 3 wt. %, alternatively less than 2 wt. %, alternatively less than 1 wt. %, alternatively less than 0.1 wt. %, of water, based on a total weight of the primer composition.

As also introduced above, the primer composition includes a crosslinking component that can react with a crosslinkable component to form a crosslinked polymeric network, herein referred to as a crosslinked network. It is to be appreciated that the primer composition may provide improved coating performance, especially interlayer adhesion.

The term “crosslinking agent” refers to a component having “crosslinking-functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking-functional group combinations would be excluded, since, if present, these combinations would crosslink among themselves (self-crosslink), thereby destroying their ability to crosslink with the crosslinkable-functional groups. A workable combination of crosslinking-functional groups refers to the combinations of crosslinking-functional groups that can be used in coating applications excluding those combinations that would self-crosslink. One of ordinary skill in the art would recognize that certain combinations of crosslinking-functional group and crosslinkable-functional groups would be excluded, since they would fail to crosslink and produce the film forming crosslinked structures. The coating composition may include more than one type of crosslinking agent that have the same or different crosslinking-functional groups. Typical crosslinking-functional groups can include hydroxyl, thiol, acetoacetoxy, carboxyl, primary amine, secondary amine, epoxy, anhydride, ketimine, aldimine, orthoester, orthocarbonate, cyclic amide, or combinations thereof.

In embodiments, melamine compounds having melamine-functional groups may be utilized as the crosslinking agent to react with the crosslinkable-functional groups, such as hydroxyl-functional groups and amine-functional groups. In certain embodiments, only primary and secondary amine-functional groups may be reacted with the melamine-functional groups.

As also introduced above, the coating composition may further include pigment. Any pigment known in the art for use in coating composition may be utilized in the coating composition. The coating compositions may further include other additives known in the art for use in coating compositions. Examples of such additives can include ultraviolet light stabilizers, wetting agents, leveling and flow control agents, leveling agents based on (meth)acrylic homopolymers; rheological control agents; thickeners, such as partially crosslinked polycarboxylic acid or polyurethanes; and antifoaming agents. The additives can be used in conventional amounts familiar to those skilled in the art.

A method for providing a primer coating on an automotive body component is also provided herein. The method includes the step of mixing a first part comprising polyester and melamine with a second part comprising an unblocked acid catalyst to form a mixed composition. Further, the method includes applying the mixed composition to the automotive body component. Also, the method includes curing the mixed composition on the automotive body component at a temperature of less than about 120° C., such as from 100 to 110° C. The step of applying may include spraying, electro-coating, brushing, rolling, dipping, laminating, and the like.

### Example 1

Example 1 describes the composition of the first part and second part of an exemplary primer composition in Table 1.

TABLE 1

| | Weight Percent | |
|---|---|---|
| | of Primer | |
| | Composition | Component |
| FIRST | 33.298(x) | HAPS compliant polyester (crosslinking |
| PART | | component) |
| | 3.884 | Melamine formaldehyde resin (crosslinkable |
| | | component) |
| | 14.674 | Butylated melamine formaldehyde resin |
| | | (crosslinkable component) |
| | 2.908 | N-butyl alcohol (solvent) |
| | 3.683 | Isobutyl alcohol (solvent) |
| | 8.303 | Aromatic hydrocarbon (Hydrocarbon |
| | | Solvent, S-100) |
| | 16.3 | Aromatic hydrocarbon (Hydrocarbon |
| | | solvent, S-150) |
| | 0.249 | Acrylic copolymer flow additive (additive) |
| | 1.368 | HAPS compliant silica dispersion (pigment |
| | | dispersion) |
| | 2.267 | Black HAPS compliant dispersion (pigment |
| | | dispersion) |
| | 1.856 | HAPS compliant talc dispersion (pigment |
| | | dispersion) |
| | 4.496 | White polyester dispersion (pigment |
| | | dispersion) |
| | 0.277 | Brown H.S.HAPS compliant dispersion |
| | | (pigment dispersion) |
| | 5.108 | HAPS compliant acrylic dispersion |
| | | (pigment dispersion) |
| | 0.717 | Yellow HAPS compliant dispersion |
| | | (pigment dispersion) |
| SECOND | 33.298(1 − x) | HAPS compliant polyester (crosslinking |
| PART | | component) |
| | 0.612 | Aromatic Sulfonic Acid (Acid crosslinking |
| | | catalyst) |
| TOTAL | 100 | |

Wherein 0 ≤ x ≤ 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method for providing a primer coating on an automotive body component, the method comprising:
mixing a first part comprising polyester and melamine with a second part comprising an unblocked acid catalyst to form a mixed composition;
applying the mixed composition to the automotive body component; and
curing the mixed composition on the automotive body component at a temperature of less than about 120° C.

2. The method of claim 1, wherein the second part is substantially free of isocyanate.

3. The method of claim 1, wherein the mixed composition is substantially free of isocyanate.

4. The method of claim 1, wherein the first part comprises a melamine formaldehyde resin comprising a monomeric melamine, a polymeric melamine, or any mixture thereof.

5. The method of claim 1, wherein the first part comprises a first melamine formaldehyde resin and a second melamine formaldehyde resin, wherein the second melamine formaldehyde resin is a butylated melamine formaldehyde resin, and wherein the total amount of the first melamine formaldehyde resin and the second melamine formaldehyde resin is less than 30 weight percent of the total weight of the mixed composition.

6. The method of claim 1, wherein the polyester comprises from about 15 to about 20 percent by weight of the mixed composition, based on the total weight of the mixed composition.

7. The method of claim 1, wherein the polyester comprises from about 25 to about 50 percent by weight of the mixed composition, based on the total weight of the mixed composition.

8. The method of claim 1, wherein the polyester comprises from about 30 to about 40 percent by weight of the mixed composition, based on the total weight of the mixed composition.

9. The method of claim 1, wherein the polyester and melamine are provided in a polyester:melamine weight ratio of from about 1.5:1 to about 2:1.

10. The method of claim 1, wherein the mixed composition is a solventborne coating composition and comprises no water or less than 0.1 weight percent of water, based on a total weight of the composition.

11. A method for providing a primer coating on an automotive body component, the method comprising:
providing a two-part (2k) low temperature curable primer composition comprising:
a first part comprising a first portion of a crosslinkable component and a crosslinking component; and
a second part comprising a second portion of the crosslinkable component and an unblocked acid catalyst, wherein the second part is substantially free of isocyanate;
mixing the first part and the second part to form a mixed composition;
applying the mixed composition to the automotive body component; and
curing the mixed composition on the automotive body component at a temperature of less than about 120° C.

12. The method of claim 11, wherein the crosslinking component is a melamine formaldehyde resin comprising a monomeric melamine, a polymeric melamine, or any mixture thereof.

13. The method of claim 11, wherein the crosslinking component comprises a first melamine formaldehyde resin and a second melamine formaldehyde resin, wherein the second melamine formaldehyde resin is a butylated melamine formaldehyde resin, and wherein the total amount of the first melamine formaldehyde resin and the second melamine formaldehyde resin is less than 30 weight percent of the total weight of the composition.

14. The method of claim 11, wherein the crosslinking component comprises from about 15 to about 20 percent by weight of the primer composition, based on the total weight of the primer composition.

15. The method of claim 11, wherein the crosslinkable component is polyester, and wherein the polyester comprises from about 25 to about 50 percent by weight of the primer composition, based on the total weight of the primer composition.

16. The method of claim 11, wherein the crosslinkable component is polyester, and wherein the polyester comprises from about 30 to about 40 percent by weight of the primer composition, based on the total weight of the primer composition.

17. The method of claim 11, wherein the crosslinking component is melamine, wherein the crosslinkable component is polyester, and wherein the polyester and melamine are provided in a polyester:melamine weight ratio of from about 1.5:1 to about 2:1.

18. The method of claim 11, wherein the second part consists essentially of the unblocked acid catalyst and the second portion of the crosslinkable component.

19. The method of claim 11, wherein the composition is a solventborne coating composition and comprises no water or less than 0.1 weight percent of water, based on a total weight of the composition.

20. The method of claim 11, wherein:
the composition is substantially free of isocyanate;
the unblocked acid catalyst is a crosslinking catalyst;
the first part of the primer composition is substantially free of crosslinking catalyst; and
the second part consists essentially of the second portion of the crosslinkable component and the unblocked acid catalyst.
